(19) United States
(12) Patent Application Publication
(10) Pub. No.: US 2003/0065748 A1
(43) Pub. Date: Apr. 3, 2003

(54) System and method of database processing

(76) Inventor: Satoshi Fuyuno, Tokyo (JP)

Correspondence Address: CHRISTIE, PARKER & HALE, LLP, P.O. BOX 7068, PASADENA, CA, 91109-7068, US

(21) Appl. No.: 10/232,950

(22) Filed: Aug. 30, 2002

(30) Foreign Application Priority Data
Aug. 31, 2001 (JP) 2001-265106

(51) Int. Cl. G06F 15/16

(52) U.S. Cl. 709/219

(57) ABSTRACT

A method and apparatus for database processing. A database processing system includes a web server for transmitting and receiving data with a user terminal via a network, a database server to store information about content, and a content server for processing a database processing request received from the user terminal. The content server has a memory and a database structure generated in the memory for storage of content received from the database server. The content server may be backed up using the database server or by another dedicated backup server on a periodic basis or on an event driven basis.

### CROSS-REFERENCE TO RELATED APPLICATION

The present application claims priority to Japanese Patent Application No. 2001-265106, filed Aug. 31, 2001, which is hereby incorporated by reference as if set forth in full herein.

### BACKGROUND OF THE INVENTION

This invention relates generally to database processing systems and database processing methods and more specifically to high-speed or complicated database processing via a network.

Conventionally, in a case of processing a database via a network, database servers are used to directly process the database from a user terminal owned by a user via a web server or the like, and also to transmit a database processing result to the user terminal via the web server and the network. Generally, processing the database has been conducted solely by the database server particularly when there is no need for complicated processing of the database content via the network, or when there is a low frequency of complicated processing, or when there is a need for easy recovery of the database after a fault during processing. In a case where the database server processes the database according to the above conditions, it is basically desirable to use at least one database server for one target content for database processing.

In addition, the database server conducts the database processing itself after a process of once integrating tables required to process the database and then retrieving all data of the integrated tables, so that it is difficult to raise processing speed because of the limit of the processing speed of the database server. Furthermore, the number of simultaneously executing processes accessing the database is restricted, so that the database server, if used to process the database by referring to a plurality of tables at a time, degrades its response remarkably and hence, causes a delay in transmitting a result of the database processing to the user.

Conventionally, the above methods might suffice to handle the database processing via the network, because of the need for only simple processing in most cases. However, with a rapid development of the networking capabilities, database processing via a network is becoming more complicated, and the frequency of complicated processing is on the increase as well.

In one way to overcome the above existing conditions, database processing is presently handled by using a plurality of database servers, each of which are capable of processing the same database, for the database processing in the manner of distributing the database processing to these database servers, or alternatively, the processing capability of the database server itself is increased by increasing the processing power of the database server.

However, database servers are generally expensive, so that increased costs are required to set up the plurality of database servers for the content. In addition, a high cost is similarly required to improve the processing capability of the database server itself.

### SUMMARY OF THE INVENTION

A method and apparatus for database processing is provided. A database processing system includes a web server for transmitting and receiving data with a user terminal via a network, a database server to store information about content, and a content server for processing a database processing request received from the user terminal. The content server has a memory and a database structure generated in the memory for storage of content received from the database server. The content server may be backed up using the database server or by another dedicated backup server on a periodic basis or on an event driven basis.

In one aspect of the invention, data management conventionally conducted for database content stored on a database server is conducted by setting up a content server between a web server and the database server. The content server has a memory for creating a database structure of the database server which eliminates the need to process a database content processing request from a user terminal on the database server directly.

Conventionally, in a case of database processing for a plurality of tables, the database processing has been made possible through a process of integrating target tables for processing and then retrieving the entire integrated tables. In another aspect of the present invention, the need for integration of the tables is eliminated making it possible to process a database directly by creating database structure in the memory of the content server. Thus, the present invention provides a database processing system and a database processing method which may increase the speed of complicated database processing enabling high-speed and complicated database processing simultaneously without the need for additional database servers.

In another aspect of the invention, a database processing system for processing database content by a user using a user terminal via a network is provided. The database processing system includes a web server for transmitting and receiving data to and from the user terminal via the network and for accepting a database processing request from the user terminal, and a content server for conducting the processing for the database processing request using a database structure in the memory of the content server to store information about the content.

In another aspect of the invention, a method is provided for processing database content by a user using a user terminal via a network. The method includes the steps of creating a database structure in the memory of a content server, storing information about the content in the database structure created in the memory of the content server, receiving a database processing request from the user terminal, and conducting the processing for the received database processing request using the database structure created in the memory of the content server.

In addition, the database processing conducted not on the database but in memory of the content server has conventionally resulted in a failure in processing of a pertinent database unless the process of integrating the tables of the database and then retrieving the integrated tables from the beginning is completed. On the other hand, the database processing conducted after a database structure is created in the memory of the content server in accordance with the present invention makes it possible to designate target data for processing directly using a memory address. In doing so, processing directly in memory is achieved wherein the speed of the processing in memory is higher than the processing speed in the database server, permitting a reduction in overall processing time.

In another aspect of the invention, a database processing system for processing a database for content with a user terminal owned by a user via a network is provided. The database processing system includes a web server for transmitting and receiving data with the user terminal via the network and for accepting a database processing request from the user terminal, a database server that stores information about the content, and a content server for conducting the processing for the database processing request from the user terminal using a database structure of the database server in the memory of the content server. The content server extracts information about the target content for database processing from the database server to store the extracted information about the content in the database structure.

In another aspect of the invention, a database processing system for processing database content by a user using a user terminal via a network includes a web server for receiving database processing requests from the user terminal via the network and a content server coupled to the web server. The content server includes a database structure stored in memory for storage of content to be processed by the content server. The content server processes the content using the database processing request received from the web server.

In another aspect of the invention, the database processing system further comprises a database server coupled to the content server for storage of the content and storage of information about the content.

In another aspect of the invention, the content server backs up the database structure created in the memory of the content server in the database server on a regular or irregular basis.

In another aspect of the invention, a database processing system for processing database content by a user using a user terminal via a network includes a web server for transmitting and receiving data with the user terminal via the network and for accepting a database processing request from the user terminal and a content server for processing the database processing request using a database structure in a memory to store information about the content of a plurality of users in the database structure.

In another aspect of the invention, the database processing system further comprises a database server for storage of user information, the user information including user authenticating information.

In another aspect of the invention, the database processing system further comprises a backup server for backing up the database structure created in the memory of the content server on a regular or irregular basis.

In another aspect of the invention, a method for processing database content by a user using a user terminal via a network is provided. A database structure is generated in the memory of a content server and information about the database content is stored in the database structure created in the memory of the content server. The content server receives a database processing request from the user terminal and conducts the processing for the received database processing request in the data base structure created in memory of the content server.

In another aspect of the invention, information about the database content is stored in a database server. A database structure of the database server is generated a in a memory of a content server. The content server receives a database processing request from the user terminal, extracts information about the content for database processing from the database server using the database processing request, stores the extracted information about the content in the database structure in the memory, and conducts the processing for the received database processing request in the database structure created in the memory of the content server.

In another aspect of the invention, the method of database content processing further includes the step of storing the database structure created in the memory of the content server in the database server on a regular or irregular basis.

In another aspect of the invention, a method for processing database content by a user using a user terminal via a network includes the steps of: creating a database structure in a memory of a content server to store information about the content of a plurality of users; receiving a database processing request from the user terminal; and conducting the processing for the received database processing request in the database structure created in the memory of the content server.

In another aspect of the invention, the database processing method further includes the step of storing user information in a database server coupled to the content server with the user information including user authenticating information In another aspect of the invention, the database processing method further includes the step of backing up the database structure created in the memory of the content server in a backup server coupled to the content server on a regular or irregular basis.

### BRIEF DESCRIPTION OF THE DRAWINGS

These and other features, aspects, and advantages of the present invention will become better understood with regard to the following description, appended claims, and accompanying drawings where:

FIG. 1 is a block diagram showing a system configuration in accordance with an exemplary embodiment of the present invention;

FIG. 2 is a flowchart showing a flow of a process in accordance with an exemplary embodiment of the present invention;

FIG. 3 is a flowchart showing a flow of a process in accordance with an exemplary embodiment of the present invention; and

FIG. 4 is a block diagram of a content server in accordance with an exemplary embodiment of the present invention.

### DETAILED DESCRIPTION OF THE INVENTION

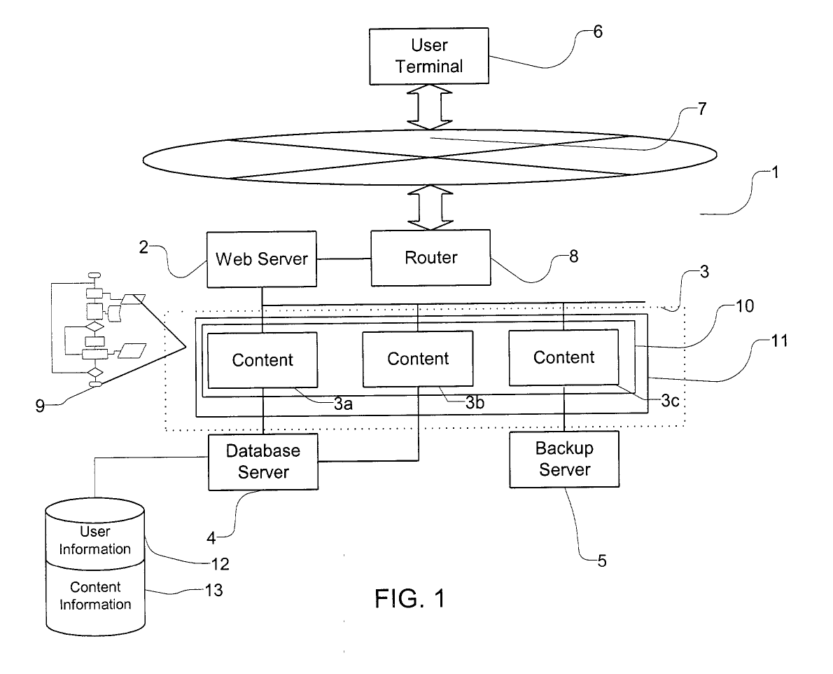

FIG. 1 is a block diagram showing a system configuration in accordance with an exemplary embodiment of the present invention. In the exemplary embodiment, the database processing system is used to serve a game as described herein and it is to be understood that other database content may be served by other exemplary database processing systems in accordance with the present invention. A database processing system 1 transmits and receives data with a user terminal 6, such as a game machine having a network function, owned by a user via a network 7. The database processing system has a web server 2 coupled to a content server 3 which is coupled to a database server 4 and also coupled to a backup server 5. In operation, web server 2 transmits and receives data with user terminal 6 via network 7 by using a router 8 and the like.

Content server 3 is a server that processes a database for content 3a, 3b, and 3c, such as content for a game, after creating a database structure 10 in a memory location 11 of content server 3. Content server 3 has a program 9 for processing of the database content stored in memory 11. In one embodiment of a database processing system in accordance with the present invention, the program is for a game played over network 7 by a plurality of users. In other embodiments, the program can be for other kinds of database processing. As such, the details of the program are not specified herein. The program may select and transmit images, documents, music, or the like included in the content (such as the images and sounds of a game) to user terminal 6 by making use of database structure 10 created in memory 11.

Database server 4 stores content such as a user's authentication information 12 or information about the content 13. For example, if a game is being served by the server, information about the game such as user information, player history information, and event information, for instance, are stored on the database server.

The backup server 5 is a server that backs up the database created in memory 11 of content server 3 either on a regular or irregular basis as needed. For example, backup server 5 may periodically create a backup of the contents in the content server. As another example, backup server 5 may initiate a backup operation when some event occurs such as when a new user accesses content server 3 via network 7.

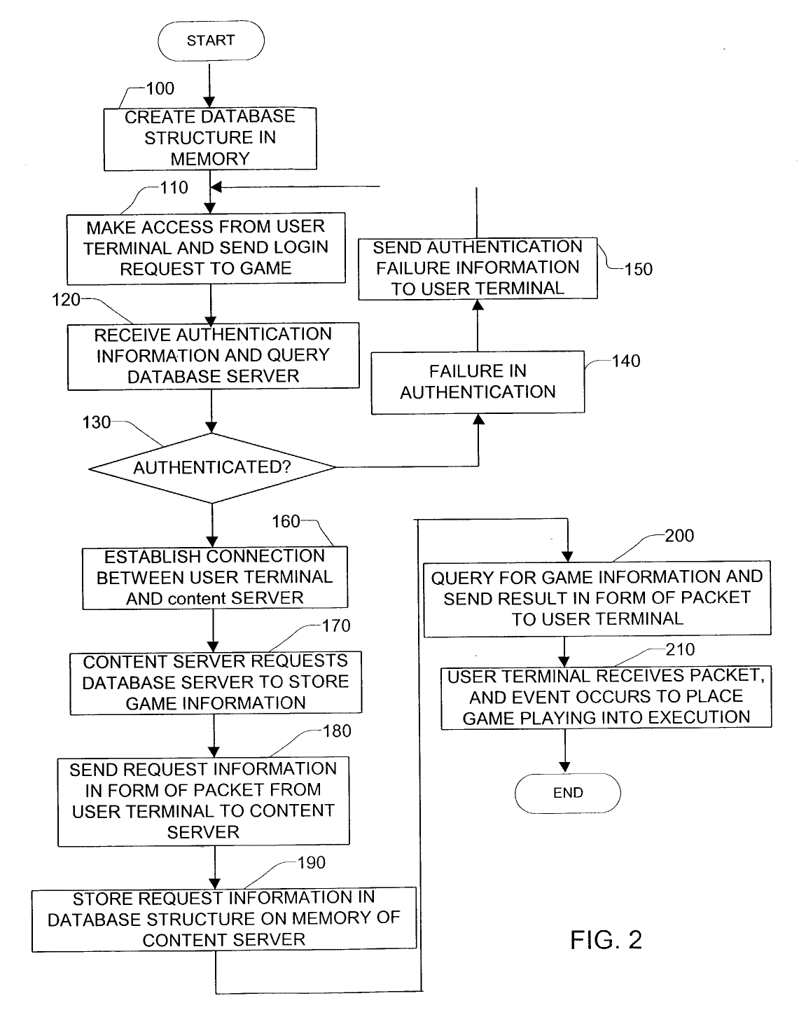

Referring to both FIG. 1 and FIG. 2, a description will now be given of an exemplary embodiment of the present invention. A flow of a process of the present invention will now be described in detail with reference to a flowchart in FIG. 2 as well as the block diagram showing the system configuration in FIG. 1. The exemplary embodiment is a description of contents server 3 being used in conjunction with program 9 to serve game information where the game information is made available to a large number of users. The game example is an exemplary embodiment and those skilled in the art of database processing will recognize that the gaming aspects of the exemplary embodiment are not a limitation of the present invention. More specifically, there is shown a case where only the game information actually processed is stored in database structure 10 created in memory 11 of content server 3. In the exemplary game embodiment, the database processing is achieved using a Personal Computer (PC) game machine (which will be hereinafter referred to as a game machine) having a network function as user terminal 6.

Content server 3 creates a database structure for content received from database server 4, such as database structure 10 in memory 11 for content 3a, upon initialization where there is an absence of any database structure in memory 11 such as when content server 3 is started or the first user makes an access (step 100). While it is possible to create database structure 10 in memory 11 of content server 3 at a point of time when content server 3 is started or a first user makes an access, those skilled in the art of database processing will understand that database structure 10 may be created at other times as well. In one content server in accordance with an exemplary embodiment of the present invention, database structure 10 is created in memory 11 when content server 3 is started. In such an embodiment, step 100 is not required. In addition, in a case where database structure 10 is created in memory 11 when the first user makes an access, step 100 is not repeated for subsequent users on and after the second user who makes an access. That is, database structure 10 created in memory 11 is a single database structure for all users accessing content server 3.

In a case of using game playing for the first time, a user may transmit the user's attribute information (such as name, address, telephone number and E-mail address, for instance) from user terminal 6 to database server 4 for registration as needed. In this case, authentication information, such as a user ID and a password, is stored in database server 4. The user transmits a login request from user terminal 6 owned by the user to a target game for accessing via network 7 (step 110).

Web server 2 receives the login request transmitted from user terminal 6 in step 110 together with the authentication information, and then queries database server 4 about the presence of a user having the authentication information (step 120). In one database server in accordance with an exemplary embodiment of the present invention, the database server receives queries in SQL which is a database processing language.

Database server 4 accepts the above query and retrieves the authentication information in order to authenticate the user (step 130). Database server 4 makes authentication on regular bases such that the user is confirmed using the authentication information, or transmits back the fact that authentication failed to web server 2 in the event of an authentication failure (step 140). Then, web server 2 notifies user terminal 6 of authentication failure information (step 150).

When the authentication is made properly in step 130, a connection between user terminal 6 and content server 3 is established (step 160).

After establishment of the connection in step 160, content server 3 requests database server 4 to transmit game information and the like of the authenticated user (step 170) to content server 3. Game information such as user information, player history information and event information in database server 4 is stored in the database in memory 11 of content server 3 in response to the request to store generated in step 170. That is, the game information and the like of the user who is making an access is stored in database structure 10 in memory 11 of content server 3 after being extracted from database server 4. Thus, assuming that the users who are now playing the game via content server 3 are as many as 100 out of 10,000 game users in total registered in database server 4, for instance, the game information and the like for 10,000 game users are stored in database server 4 itself, whereas the game information that is stored in database structure 10 stored in memory 11 of content server 3 is no more than the game information for 100 users who are actually playing the game.

Thus, in a case of using a prior-art database server, it is necessary to process the database of the game information through the process of once integrating the tables for all 10,000 users and then referring to the integrated tables, in consideration of the characteristics of the prior-art database server, even though the users who are actually playing the game are merely as many as 100 out of 10,000 game users in total, for instance. However, use of the present invention makes it possible to conduct database processing using the contents of content server 3 with reduced memory requirements and increased processing speed. Memory requirements are reduced because less data is stored in memory 11 of content server 3 than in the database of database server 4. For example, if 10,000 users are authorized to access a game from database server 4 but only 100 users are currently playing the game, only the user information for the 100 users need be stored in memory 11 of content server 3 instead of all 10,000 users. In addition, use of the present invention makes it possible to directly designate a data address in memory 11 of content server 3 for a user's information. As memory access is generally faster than database access, user information may be more readily accessed from content server 3 than database server 4. Finally, as memory 11 in content server 3 may be accessed by multiple processes simultaneously, content server 3 allows multiple parallel processes to access and update user information simultaneously thus improving the throughput of content server 3 as compared to database server 4.

The user transmits request information including user identification information (user information) in the form of packets from the game software and the like installed in user terminal 6 to content server 3 via network 7 (step 180). The request information may represent a processing request and the like for database structure 10 of content server 3 and the user information (also including a processing request and the like for a game program installed in content server 3).

Content server 3 receives the packets transmitted in step 180, reads the user information from the packet and then stores the necessary request information in database structure 10 in memory 11 of content server 3 (or after processing the request information as needed) (step 190). The reason why only the necessary request information is stored in this step is because the request information may include not only a request for processing for database structure 10 in memory 11 and also a request for processing by a game program 9 and the like that are preliminarily installed in content server 3. That is, the processing in the game program and the like is completed whenever the request information including the processing for database structure 10 is stored in database structure 10. On the other hand, there is no need to store the request information in database structure 10, if no processing for database structure 10 causes an update in data structure 10.

In addition, content server 3 makes queries for the game information stored in database structure 10 in memory 11 of content server 3, receives a result in response to the queries and then transmits the result in the form of packets to user terminal 6 (step 200). That is, the database is processed in database structure 10 created in memory 11 of content server 3, and a result of the database processing is transmitted in the form of packets to user terminal 6.

User terminal 6 receives the packets from content server 3, and as a result, some event occurs on user terminal 6 to place game playing into execution on user terminal 6 (step 210). In addition, although not shown in the flowchart, content server 3 may be recovered from a fault by backing up the content of the database created in memory 11 of content server 3 in database server 4 on a regular or irregular basis as previously described. Furthermore, backup server 5 may be used to backup content server 3 in the case where backup operations would adversely affect database server 4's performance or security.

In addition, a description will now be given of the flow of the process from step 160 to step 210 with reference to an exemplary embodiment of the present invention. After establishment of the connection between user terminal 6 and content server 3 in step 160, content server 3 requests database server 4 to store the game information of the user who has finished establishment of a connection (step 170).

Content server 3 stores the game information of the pertinent user in database structure 10 in memory 11 after extracting the above game information from database server 4 on the basis of the query created in step 170. As the result of the storage of the extracted game information, content server 3 transmits information such as images and characters to user terminal 6. User terminal 6 receives the transmitted information, and some action (operation, judgment and the like) is taken on the received information by the user through user terminal 6, so that the received information is changed to request information which is then transmitted in the form of packets from user terminal 6 to content server 3 (step 180).

Content server 3 receives the request information transmitted in step 180, interprets the request information and then stores the necessary request information as it is in database structure 10 in memory 11 or after processing the request information (such as changing coordinates and current position data for the request information on operations) (step 190).

Content server 3 generates information such as images and characters on the basis of the request information, queries for the information and the like stored in database structure 10 in memory 11 and then transmits a result of the query in the form of packets to user terminal 6 (step 200).

User terminal 6 receives the information transmitted from content server 3 in step 200, and as a result, an event and the like occur on user terminal 6 (step 210). In this manner, a game may be played by a user using user terminal 6 by repeating steps 180 to 210 in this manner.

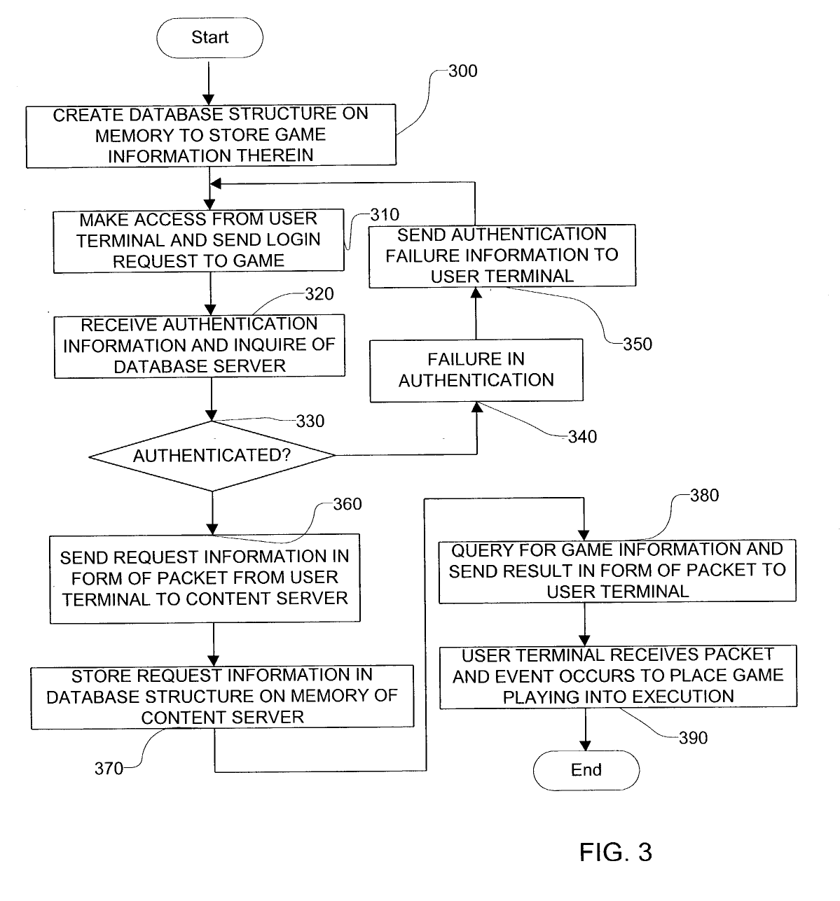

A description will now be given of a second embodiment in accordance with the present invention mainly in a case where game information is restricted (a case where game information is available in small numbers). More specifically, in this example, the game information of all users is stored in database structure 10 created in memory 11 of content server 3. Use of a cellular phone or the like having a network function as user terminal 6 when the game is applied to the content is specifically given as one embodiment. A process flow in the second embodiment will now be given in detail with reference to a flowchart in FIG. 3 as well as the block diagram showing the system configuration in FIG. 1.

The feature of the previous embodiment is that solely the game information of the target users for processing (that is, the users who are actually playing the game after connection to network 7) is stored in database structure 10 in memory 11 of content server 3 after being extracted from database server 4. On the other hand, according to the second embodiment, the game information of all the users is stored in database structure 10 in memory 11 of content server 3 without necessarily storing the game information in database server 4. This means that user game information available for the database processing in a case of using the game machine as user terminal 6 is diversified (in large numbers) in general, so that a mass memory region is required on the assumption that the game information stored in database structure 10 in memory 11 covers game information of users who are not playing the game. On the other hand, the user game information available for the database processing in a case of using the cellular phone and the like as user terminal 6 is restricted (in small numbers), so that a required memory region may be restricted even if the game information of all the users is stored in database structure 10 in memory 11. The previous embodiment may also be configured to store the game information of all the users in database structure 10 in memory 11, or alternatively, the second embodiment is also configured to store the game information of only the users who are playing the game in database structure 10.

Referring now to the flowchart of FIG. 3, content server 3 creates database structure 10 in memory 11 at a point of time when content server 3 is started, and stores the game information of all the users, who are game players, in database structure 10 (step 300). That is, in a case of playing the game for the first time, the user game information is stored with an initial value in database structure 10 created in memory 11. If a game with a membership system is available, for instance, it may be arranged that solely data such as authentication information, which needs to be surely held as required data, is stored in database server 4, while other game information is directly stored in database structure 10 created in memory 11 of content server 3.

The user transmits a login request to a target game for accessing from user terminal 6 owned by the user via network 7 (step 310). In this case, it is a matter of course that the authentication information such as user ID and password is also sent.

Web server 2 receives the login request transmitted from user terminal 6 in step 310 together with authentication information, and queries database server 4 about the presence of a user having the authentication information (step 320). In this case, it is desirable to make an query in the SQL language that is the database processing language.

Database server 4 accepts the query and retrieves the authentication information (step 330). Then, database server 4 makes authenticates, or transmits back the fact that authentication failed, to web server 2 in the absence of the authentication information (step 340). The web server 2 notifies user terminal 6 of authentication failure information (step 350).

When the authentication is regularly made in step 330, a connection between user terminal 6 and content server 3 is established, so that the user transmits game request information inclusive of user identification information (user information) in the form of packets from user terminal 6 to content server 3 via network 7 (step 360). The request information used herein represents a processing request and the like for database structure 10 of content server 3 and the game information (also including a processing request and the like for the game program installed in content server 3).

Content server 3 receives the packet transmitted in step 360, reads the user information from the packet and then stores the necessary request information in database structure 10 in memory 11 of content server 3 (or after processing the request information as needed) (step 370). The reason why only the necessary request information is stored in this step is because the request information may include a processing request for database structure 10 in memory 11 and also a processing request for the game program and the like preliminarily installed in content server 3 for the processing for database structure 10. That is, the processing in the game program and the like is completed whenever the request information including the processing for database structure 10 is stored in database structure 10. On the other hand, there is no need to store the request information in database structure 10 if no processing for database structure 10 occurs.

In addition, content server 3 makes queries of the game information stored in the database in memory 11 of content server 3, receives a result in response to the queries, and then transmits the result in the form of packets to user terminal 6 (step 380). That is, the database relating to the game from user terminal 6 is processed. More specifically, the processing request from user terminal 6 is processed in database structure 10 created in memory 11 of content server 3, and a result of the processing is transmitted in the form of packets to user terminal 6.

User terminal 6 receives the packet from content server 3, and as a result, some event occurs on user terminal 6 to place game playing into execution on user terminal 6 (step 390). Although not shown in the flowchart, content server 3 may be recovered from a fault by backing up the content of the database created in memory 11 of content server 3 with the backup server 5 as previously described.

In addition, a description will now be given of the flow of the process from step 360 to step 390 with reference to an exemplary embodiment in accordance with the present invention. After establishment of the connection between user terminal 6 and content server 3, content server 3 transmits information such as images and characters to user terminal 6. User terminal 6 receives the transmitted information, and some action (operation, judgment and the like) is taken on the received information by the user through user terminal 6, so that the received information is changed to the request information, which is then transmitted in the form of packets from user terminal 6 to content server 3 (step 360).

Content server 3 receives the request information transmitted in step 360, interprets the request information and then stores the necessary request information as it is in database structure 10 in memory 11 or after processing the request information (such as changing coordinates and current position data for the request information on operations) (step 370).

Content server 3 generates the information such as image and character on the basis of the request information, checks for the information and the like stored in database structure 10 in memory 11 and then transmits a result of check in the form of packet to user terminal 6 (step 380).

User terminal 6 receives the information transmitted from content server 3 in step 380, and as a result, an event and the like occur on user terminal 6 (step 390). The progress of game playing is caused on user terminal 6 by repeating steps from step 360 to step 390 in this manner.

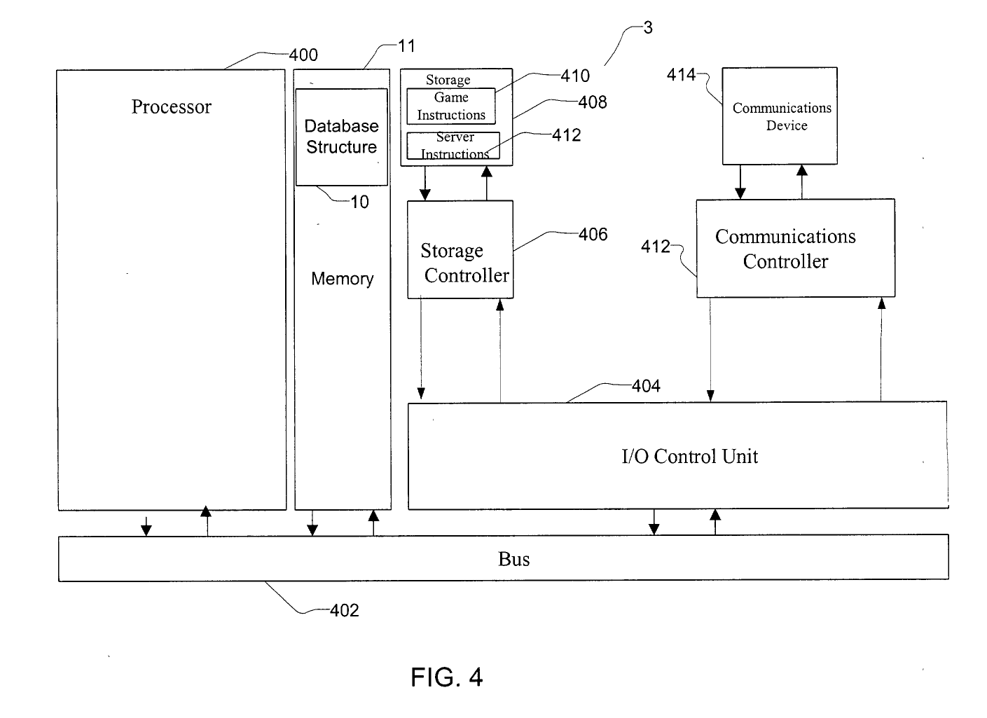

FIG. 4 is a block diagram of a content server in accordance with an exemplary embodiment of the present invention. A content server 3 includes a processor 400 coupled to a memory 11 and an I/O control unit 404 via a bus 402. Processor 400 is also coupled to a storage controller 406 via I/O control unit 404. Storage controller 406 is coupled to a storage device 408. game program instructions 410 and server program instructions 412 are stored on storage device 408. In operation, processor 400 retrieves server program instructions 412 from storage device 408 and stores server program instructions 412 in memory 11. Processor 400 then executes server program instructions 412 stored in memory 11 to implement the features of a content server as previously described such as creating database structure 10 in memory 11. Processor 400 then retrieves game program instructions 410 and stores game program instructions 410 in memory 11. Processor 400 executes game program instructions 410 to implement the features a game as previously described.

Processor 400 is further coupled to a communications controller 412 via bus 402 and I/O control unit 404. Communications controller 412 is further coupled to communications device 414. Communications device 414 is coupled to previously described web server 2, database server 4, and backup server 5 (all of FIG. 1) as previously described. In operation, game program 9 (of FIG. 1) implemented by game program instructions 410 uses communications device 414 to receive database processing requests from web server 2 (of FIG. 1). The game program processes the database processing instructions, generating a database process result as previously described, and transmits the database process result to web server 2 via communications device 414. A content server implemented by content server program instructions 412 also uses communications device 414 to get database content from database server 4 (of FIG. 1) as previously described. The content server also uses communications device 414 to backup the contents of database structure 10 to either database server 4 or backup server 5 (of FIG. 1) as previously described.

The present invention has the following effects.

Use of a process and system in accordance with the present invention makes it possible to conduct data management, which has been conventionally conducted on the database server, separately from the processing of managed data, permitting high-speed and complicated database processing simultaneously in a short period of time.

That is, the conventional database processing systems have resulted in a failure in processing of the necessary database unless the process of integrating the tables of the database in the database server and then retrieving the integrated tables from the beginning is completed. On the other hand, as described herein, the database processing conducted after the database is created in memory 11 of content server 3 to store information stored in the database server in database structure 10 (all of FIG. 1) makes it possible to designate target data for processing by a memory address directly, so that the processing speed may be increased more than that in a case of using solely the database server like the related art. Further, processing in memory 11 is realized, so that the processing speed may be increased over that of the processing in the database server.

Use of a content server set up between web server 2 and database server 4 (both of FIG. 1) as described herein makes it possible to increase processing speed. While it has been conventionally necessary to set up a plurality of database servers or improve the processing capability of the database server itself in order to increase the processing speed, the present invention may increase the overall processing speed more than that in the related art solely by setting up a single content server thus producing an effect of reducing costs.

According to measured values in a load test conducted using an embodiment of the present invention, when processing a database for as many as 100,000 users, when accessing a general main menu, it takes as long as 3,168,800 milliseconds as the average processing time for the processing with a conventional database server. On the other hand, it takes only 451,052 milliseconds as the average processing time for processing with the embodiment of a database processing system in accordance with the present invention. Thus, use of a database processing system in accordance with the present invention reduces the processing time approximately by one seventh.

In the above load test, it is necessary to use seven conventional database servers for the above processing by distributing the processing to the conventional database servers. On the other hand, the present invention eliminates the need to set up the expensive conventional database servers as only one database server and one content server may enable high-speed and complicated processing of the database content.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents.

What is claimed is:

1. A database processing system for processing database content by a user using a user terminal via a network, comprising:
a web server for receiving database processing requests from the user terminal via the network; and
a content server coupled to the web server, the content server including a database structure stored in memory for storage of content to be processed by the content server using the database processing request received from the web server.

2. The database processing system of claim 1, further comprising a database server coupled to the content server for storage of the content and storage of information about the content.

3. The database processing system of claim 2, wherein the content server stores the database structure created in the memory of the content server in the database server on a regular basis.

4. The database processing system of claim 2, the content server stores the database structure created in the memory of the content server in the database server on an irregular basis.

5. A database processing system for processing database content by a user using a user terminal via a network, comprising:
a web server for transmitting and receiving data with the user terminal via the network and for accepting a database processing request from the user terminal; and
a content server for processing the database processing request using a database structure in a memory to store information about the content of a plurality of users in the database structure.

6. The database processing system of claim 1 or 5, further comprising a database server coupled to the content server for storage of user information, the user information including user authenticating information.

7. The database processing system of claims 1, 2, 3, 4, or 5, further comprising a backup server coupled to the content server for backing up the database structure created in the memory of the content server on a regular basis.

8. The database processing system of claim 1, 2, 3, 4, or 5, further comprising a backup server coupled to the content server for backing up the database structure created in the memory of the content server on an irregular basis.

9. A method for processing database content by a user using a user terminal via a network, comprising the steps of:
generating a database structure in a memory of a content server;
storing information about the content in the database structure created in the memory of the content server;
receiving a database processing request from the user terminal; and
conducting the processing for the received database processing request in the data base structure created in the memory of the content server.

10. A method for processing database content by a user using a user terminal via a network, comprising the steps of:
storing information about the content in a database server;
creating a database structure of the database server in a memory of a content server;
receiving a database processing request from the user terminal;
extracting information about the content for database processing from the database server using the database processing request;
storing the extracted information about the content in the database structure in the memory of the content server; and
conducting the processing for the received database processing request in the database structure created in the memory of the content server.

11. The database processing method of claim 10, further comprising the step of storing the database structure created in the memory of the content server in the database server on a regular basis.

12. The database processing method of claim 10, further comprising the step of storing the database structure created in the memory of the content server in the database server on an irregular basis.

13. A method for processing database content by a user using a user terminal via a network, comprising the steps of:
creating a database structure in a memory of a content server to store information about the content of a plurality of users;
receiving a database processing request from the user terminal; and
conducting the processing for the received database processing request in the database structure created in the memory of the content server.

14. The database processing method of claim 10 or 13, further comprising the step of storing user information in a database server coupled to the content server, the user information including user authenticating information.

15. The database processing method of claims 10, 11, 12, or 13, further comprising the step of backing up the database structure created in the memory of the content server in a backup server coupled to the content server on a regular basis.

16. The database processing method of claims 10, 11, 12, or 13, further comprising the step of backing up the database structure created in the memory of the content server in a backup server coupled to the content server on an irregular basis.

17. A content server characterized by creating a database structure in a memory to store information about content in the created database structure for processing database content in the database structure.

18. A database processing system for processing database content by a user using a user terminal via a network, comprising:
a web server means for receiving database processing requests from the user terminal via the network; and
a content server means coupled to the web server means, the content server means including means for storing a database structure in memory, the data structure for storage of content to be processed by the content server using the database processing request received from the web server means.

19. A database processing system, comprising:
receiving means for receiving a database processing request from a user terminal through a network;
database storage means for storing database content;
storage means coupled to the web server means and the database storage means for storing a database structure in memory, the database structure for storage of the database content; and
processing means coupled to the storage means for processing the database processing request using the database structure in memory.

20. The database processing system of claim 19, further comprising backup means coupled to the storage means for backup of the database structure.
